(19) United States
(12) Patent Application Publication
(10) Pub. No.: US 2026/0264493 A1
(43) Pub. Date: Sep. 10, 2026

(54) DOOR ASSEMBLY

(71) Applicants: Hyundai Motor Company, Seoul (KR); Kia Corporation, Seoul (KR)

(72) Inventor: Won Ki Song, Hwaseong-si (KR)

(21) Appl. No.: 19/262,297

(22) Filed: Jul. 8, 2025

(30) Foreign Application Priority Data
Mar. 7, 2025 (KR) 10-2025-0029617

(51) Int. Cl. B60J 10/84; B60J 10/25

(52) U.S. Cl. CPC B60J 10/84; B60J 10/25

(57) ABSTRACT

A clamshell door assembly can include an outer frame including a filler member, a roof panel connected to an upper portion of the outer frame, a side panel connected to one side of the outer frame to cover one side of the filler member and at least partially underlapping the roof panel, a side cover connected to the other side of the outer frame to cover the other side of the filler member and at least partially underlapping the roof panel, a roof sealing portion disposed on an inner surface of the roof panel, and a filler member sealing portion disposed on an outer surface of the filler member.

### CROSS-REFERENCE TO RELATED APPLICATIONS

This application claims benefit of priority to Korean Patent Application No. 10-2025-0029617 filed on Mar. 7, 2025 in the Korean Intellectual Property Office, the disclosure of which is incorporated herein by reference in its entirety.

### TECHNICAL FIELD

The present disclosure relates to a door assembly.

### BACKGROUND

There are various types of automobile doors. For example, there are swing type doors mainly applied to passenger cars, sliding type doors mainly applied to mid-sized vans, and hatchback type doors mainly applied to the tailgates of vans and recreational vehicles (RVs).

Meanwhile, purpose-built vehicles (PBVs) have emerged as future mobility vehicles. The possibility of expanding the functions and designs of PBVs according to the purposes thereof is significantly large. PBVs are a new type of mobility vehicle, which are not public transportation, such as buses, nor personal passenger cars. Depending on which PBV is docked to a hub, the purpose of the hub itself may change and the hub may be used as a flexible space.

In future automobiles, tailgates may be installed not only at the rear of the vehicle but also on the side, allowing passengers to enter or exit the vehicle from the side, as well as for loading cargo. Among these types of tailgates, a ‘clamshell door,’ which is split in the middle and opens up and down, has come to prominence because it requires less force and takes up less rear space than when opening and closing a large single tailgate.

### SUMMARY

An embodiment of the present disclosure can provide a clamshell door assembly capable of improving watertightness.

An embodiment of the present disclosure can provide a clamshell door assembly capable of reducing manufacturing costs, improving joint rigidity, and being advantageous in weight reduction.

According to an embodiment of the present disclosure, a clamshell door assembly can include: an outer frame including a filler member; a roof panel connected to an upper portion of the outer frame; a side panel connected to one side of the outer frame to cover one side of the filler member and at least partially overlapping the roof panel; a side cover connected to the other side of the outer frame to cover the other side of the filler member and at least partially overlapping the roof panel; a roof sealing portion provided on an inner surface of the roof panel; and a filler member sealing portion provided on an outer surface of the filler member.

According to an embodiment of the present disclosure, a clamshell door assembly can include: an outer frame including a first filler member and a second filler member; an assembled frame fixed to the outer frame; a roof panel connected to an upper portion of the outer frame and seated on the assembled frame; a side panel connected to one side of the outer frame and seated on the assembled frame; a side cover connected to the other side of the outer frame and covering the other surface of the filler member; a roof sealing portion provided on an inner surface of the roof panel; and a filler member sealing portion provided on an outer surface of the filler member.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a perspective view of a clamshell door assembly according to an embodiment of the present disclosure;

FIG. 2 is an exploded perspective view of a clamshell door assembly according to an embodiment of the present disclosure;

FIG. 3 is an exploded perspective view of a clamshell door assembly according to an embodiment of the present disclosure viewed at a different angle from FIG. 2;

FIG. 4 is an exploded perspective view illustrating a coupling relationship between an outer frame and an assembled frame according to an embodiment of the present disclosure;

FIG. 5 is a bottom view of a roof panel according to an embodiment of the present disclosure;

FIG. 6 is a cross-sectional view taken along line A-A’ of FIG. 1;

FIG. 7 is an enlarged view of portion B of FIG. 1;

FIG. 8 is a diagram illustrating a path through which water can flow in between a roof panel and a side panel according to an embodiment of the present disclosure and can be drained;

FIG. 9 is a perspective view illustrating a filler member according to an embodiment of the present disclosure;

FIG. 10 is a top side view of a filler member according to an embodiment of the present disclosure;

FIG. 11 is a cross-sectional view taken along line C-C’ of FIG. 1; and

FIG. 12 is a cross-sectional view taken along line D-D’ of FIG. 1.

### DETAILED DESCRIPTION OF ILLUSTRATIVE EMBODIMENTS

An embodiment of the present disclosure may be modified in various ways and take on various alternative forms, and specific example embodiments thereof are shown in the drawings and described in detail below. However, it can be understood that there is no intent to necessarily limit the present disclosure to the particular forms disclosed, but on the contrary, the present disclosure can cover modifications, equivalents, and alternatives falling within the spirit and scopes of the present disclosure.

It can be understood that, although the terms “first,” “second,” etc., may be used herein to describe various elements, these elements are not necessarily limited by these terms. These terms can be used merely to distinguish one element from another. For example, a first element could be termed a second element, and a second element could similarly be termed a first element without departing from the scope of the present disclosure. As used herein, the term “and/or” includes any and all combinations of one or more of the associated listed items.

Terms used herein to describe example embodiments of the present disclosure are not intended to necessarily limit the scopes of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It can be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, terms used herein, including technical and scientific terms, can have same meanings as understood by those skilled in the art to which the present disclosure pertains. Terms defined in generally used dictionaries can be construed to have same meanings as those of the contexts of the related art.

In the description below, terms “front,” “rear,” “above,” “below,” “top,” “bottom,” etc. used in relation to directions are described based on the illustration in the drawing.

Example embodiments of the present disclosure are described in detail with reference to the accompanying drawings.

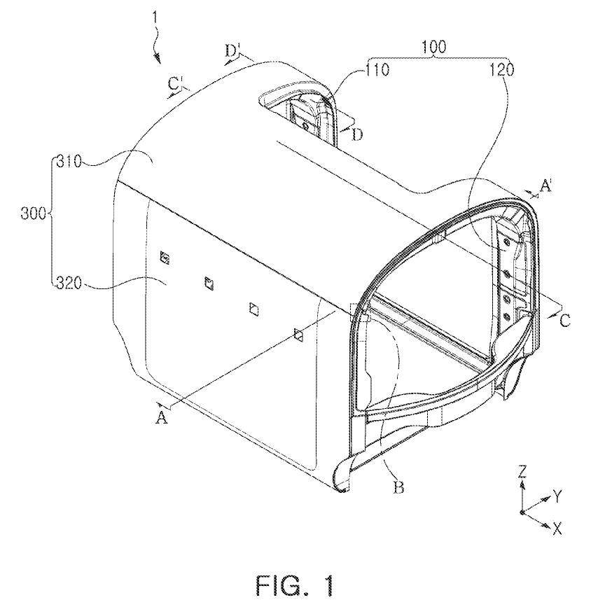

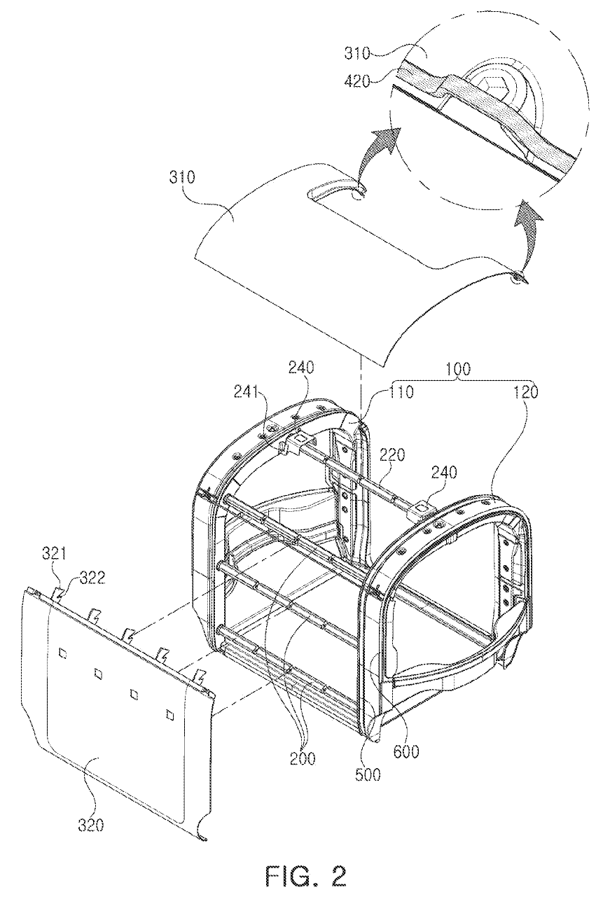

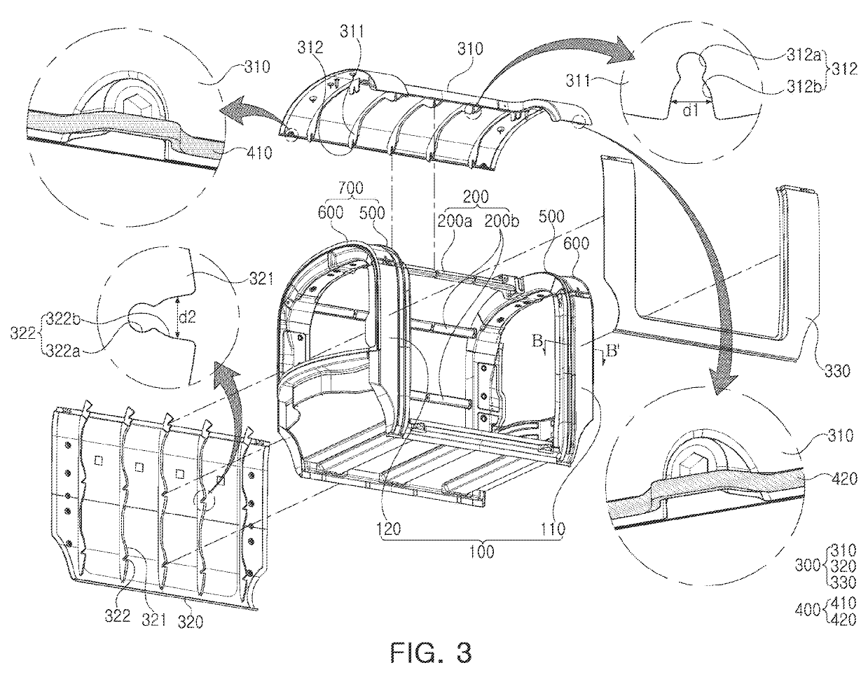

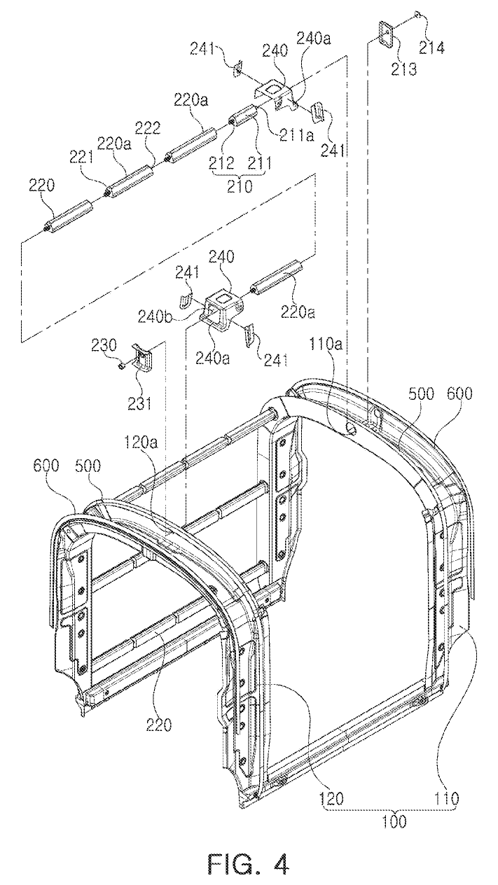

FIG. 1 is a perspective view of a clamshell door assembly according to an embodiment of the present disclosure. FIG. 2 is an exploded perspective view of a clamshell door assembly according to an embodiment of the present disclosure. FIG. 3 is an exploded perspective view of a clamshell door assembly according to an embodiment of the present disclosure viewed at a different angle from FIG. 2. FIG. 4 is an exploded perspective view illustrating a coupling relationship between an outer frame and an assembled frame according to an embodiment of the present disclosure.

Referring to FIGS. 1 to 4, a clamshell door assembly 1 according to an embodiment of the present disclosure may include an outer frame 100, an outer plate 300, a roof sealing portion 400, and a filler member sealing portion 700, any of, any combination of, or all of which may be in plural or may include plural components thereof. A clamshell door assembly 1 of an embodiment of the present disclosure can be for a vehicle passenger cabin and/or for a vehicle cargo area, which can be also a modular component for a vehicle body.

The outer frame 100 may constitute a basic skeleton of the clamshell door assembly 1. The outer frame 100 may be provided by coupling a plurality of frame modules. The outer frame 100 may include a first filler member 110 and a second filler member 120. The first filler member 110 may be provided on one side of the clamshell door assembly 1 in a length direction. The first filler member 110 may be provided in an overall inverted ‘U’ shape. Here, when defining the terms for directions, the length direction may refer to the X-axis direction in FIG. 1, a width direction may refer to the Y-axis direction in FIG. 1, and a thickness or height direction may refer to the Z-axis direction in FIG. 1.

The second filler member 120 may be provided to be spaced apart from the first filler member 110. For example, the second filler member 120 may be provided to be spaced apart from the first filler member 110 in the length direction by a set, selected, or predetermined distance. The second filler member 120 may be provided in a shape corresponding to the first filler member 110. For example, the second filler member 120 may be provided in an overall inverted ‘U’ shape. The first filler member 110 and the second filler member 120 may be connected in a length direction by a separate frame module.

One side of the assembled frame 200 may be fixed to the first filler member 110. The other side of the assembled frame 200 may be fixed to the second filler member.

The first filler member 110 and the second filler member 110 may refer to frames constituting one side and the other side in the length direction of the clamshell door assembly 1. The shapes of the first filler member 110 and the second filler member 110 may be variously changed according to structural and design needs or choices. In other words, the first filler member 110 and the second filler member 110 may be changed to various structures as long as they correspond to structures capable of supporting the assembled frame 200, the outer plate 300, etc., which will be described below, on both sides in the length direction.

The outer plate 300 may constitute an outer surface of the clamshell door assembly 1. The outer plate 300 may be seated on the assembled frame 200 and coupled to the outer frame 100. For example, both end portions of the outer plate 300 in the length direction may be coupled to the outer frame 100, and a longitudinal inner side of the outer plate 300 may be seated on the assembled frame 200. The both end portions of the outer plate 300 in the length direction may be coupled to the first filler member 110 and the second filler member 120, respectively.

The outer plate 300 may be detachably seated on the assembled frame 200. The outer plate 300 may be fixed to the outer frame 100. The outer plate 300 may include a roof panel 310, a side panel 320, and a side cover 330.

The roof panel 310 may constitute an upper surface of the clamshell door assembly 1. The roof panel 310 may be connected to an upper portion of the outer frame 100. One longitudinal side of the roof panel 310 may be coupled to the first filler member 110. The other longitudinal side of the roof panel 310 may be coupled to the second filler member 120. The roof panel 310 may be seated on the assembled frame 200.

The roof panel 310 may include a roof panel rib 311. The roof panel rib 311 may be seated on the assembled frame 200. The roof panel rib 311 may protrude from one surface of the roof panel 310. For example, the roof panel rib 311 may protrude from a bottom surface of the roof panel 310 toward the assembled frame 200. The roof panel rib 311 may be provided in a shape extending in the width direction from the bottom surface of the roof panel 310. The roof panel rib 311 may be provided in plural. For example, the plurality of roof panel ribs 311 may be provided to be spaced apart from each other at a set, selected, or predetermined distance in the length direction. One roof panel rib 311 may be seated on a plurality of assembled frames 200. For example, a roof panel rib 311 may be seated on a plurality of assembled frames 200 arranged in the width direction of the roof panel rib 311. The structure of the roof panel rib 311 may be changed to correspond to the arrangement on the assembled frame 200. In other words, as long as the roof panel rib 311 corresponds to a component protruding from the bottom surface of the roof panel 310 and seated on the assembled frame 200, the shape of the roof panel rib 311 may be changed variously to a shape commonly used in the art to which the present disclosure pertains.

The roof panel rib 311 may be provided with a roof panel rib recess 312 into which the assembled frame 200 is inserted. The roof panel rib recess 312 may be provided by an end portion of the roof panel rib 311 being recessed inward by a set, selected, or predetermined depth. At least one roof panel rib recess 312 may be provided along the roof panel rib 311. For example, a plurality of roof panel rib recesses 312 may be provided in the width direction of the roof panel rib 311.

The roof panel rib recess 312 may include a section in which a spacing d1 increases from the inner side to the outer side. The roof panel rib recess 312 may include, for example, a first seating part 312a into which the assembled frame 200 is inserted and in which at least a portion of an inner circumferential surface is in close contact with the assembled frame 200 and a first insertion part 312b extending outwardly from one side of the first seating part 312a and having a section in which the spacing d1 increases outward. An inner surface of the first seating part 312a may be provided in a shape corresponding to the outer surface of the assembled frame 200 in contact therewith. For example, the first seating part 312a may be provided in a circular shape with one side open as a hole. The first insertion part 312b may include a section in which the spacing d1 increases toward the open outer side. For example, the first insertion part 312b may be provided in a tapered shape in which the spacing d1 increases toward the open outer side. By providing the first insertion part 312b in a tapered shape, when the roof panel rib 311 is installed on the assembled frame 200, the assembled frame 200 may be easily introduced to the first seating part 312a.

The rigidity of the roof panel 310 may be improved by the roof panel rib 311. Through the roof panel rib 311, a separate rigidity reinforcing member that has to be coupled to reinforce the rigidity of the roof panel 310 may be omitted, thereby reducing the weight of the roof panel 310 and reducing the manufacturing cost.

The side panel 320 may form one surface of the clamshell door assembly 1. The side panel 320 may be connected to one side portion of the outer frame 100. For example, the side panel 320 may be connected to one side portion of the outer frame 100 in the width direction. The side panel 320 may cover one surface of the filler members 110 and 120. For example, one longitudinal side of the side panel 320 may be coupled to the first filler member 110, and the other longitudinal side of the side panel 320 may be coupled to the second filler member 120. The side panel 320 may cover one widthwise side of each of the first filler member 110 and the second filler member 120. The side panel 320 may be mounted on the assembled frame 200.

The side panel 320 may include a side panel rib 321. The side panel rib 321 may be seated on the assembled frame 200. The side panel rib 321 may protrude from one surface of the side panel 320. For example, the side panel rib 321 may protrude from one surface of the side panel 320 toward the assembled frame 200. The side panel rib 321 may be provided in a shape extending from one surface of the side panel 320 in the thickness direction. The side panel rib 321 may be provided in plural. For example, the plurality of side panel ribs 321 may be spaced apart from each other in the length direction. Any one side panel rib 321 may be seated on the plurality of assembled frames 200. For example, the side panel rib 321 may be seated on the plurality of assembled frames 200 arranged in the thickness direction of the side panel rib 321. The structure of the side panel rib 321 may be changed to correspond to the arrangement on the assembled frame 200. In other words, as long as the side panel rib 321 corresponds to a component protruding from one surface of the side panel 320 and seated on the assembled frame 200, the shape of the side panel rib 321 may be changed variously.

The side panel rib 321 may be provided with a side panel rib recess 322 into which the assembled frame 200 can be inserted. The side panel rib recess 322 may be provided by the end portion of the side panel rib 321 being recessed inwardly by a set, selected, or predetermined depth. At least one side panel rib recess 322 may be provided along the side panel rib 321. For example, a plurality of side panel rib recesses 322 may be provided in the thickness direction of the side panel rib 321.

The side panel rib recess 322 may include a section in which a spacingd2 increases from the inner side to the outer side. The side panel rib recess 322 may include, for example, a second seating part 322a into which the assembled frame 200 is inserted and in which at least a portion of an inner circumferential surface is in close contact with the assembled frame 200 and a second insertion part 322b extending from one side of the second seating part 322a to the outer side and having a section in which the spacing d2 increases outward. The inner surface of the second seating part 322a may be provided in a shape corresponding to the outer surface of the assembled frame 200 in contact therewith. For example, the second seating part 322a may be provided in a circular shape with one side open as a hole. The second insertion part 322b may include a section in which the spacing d2 increases toward the open outer side. For example, the second insertion part 322b may be provided in a tapered shape in which the spacing d2 increases toward the open outer side. By providing the second insertion part 322b in a tapered shape, when the side panel rib 321 is seated on the assembled frame 200, the assembled frame 200 may be easily introduced to the second seating part 322a.

The rigidity of the side panel 320 may be improved by the side panel rib 321. Through the side panel rib 321, a separate rigidity reinforcing member that has to be coupled to reinforce the rigidity of the side panel 320 may be omitted, thereby reducing the weight of the side panel 320 and reducing the manufacturing cost.

The side cover 330 may form the other surface of the clamshell door assembly 1. The side cover 330 may be connected to the other side portion of the outer frame 100. For example, the side cover 330 may be connected to the other side portion of the outer frame 100 in the width direction. The side cover 330 may cover the other surfaces of the filler members 110 and 120. For example, one side of the side cover 330 in the length direction may be coupled to the first filler member 110, and the other side of the side cover 330 in the length direction may be coupled to the second filler member 120. The side cover 330 may cover the other side surfaces of the first filler member 110 and the second filler member 120 in the width direction. The side cover 330 may be provided in an overall ‘U’ shape so as to be coupled to the first filler member 110 and the second filler member 120 spaced apart from each other in the length direction.

The roof sealing portion 400 may be provided on an inner surface of the roof panel 310. The roof sealing portion 400 may be provided on both end portions of the roof panel 310 in the width direction. The roof sealing portion 400 may include a first roof sealing portion 410 provided between the roof panel and the side panel 320 and a second roof sealing portion 420 provided between the roof panel 310 and the side cover 330. The roof sealing portion 400 may prevent water from flowing in between the roof panel 310 and the side panel 320 and between the roof panel 310 and the side cover 330. For example, the first roof sealing portion 410 may be provided between the roof panel 310 and the side panel 320 to prevent water from flowing in between the roof panel 310 and the side panel 320. The second roof sealing portion 420 may be provided between the roof panel 310 and the side cover 330 to prevent water from flowing in between the roof panel 310 and the side cover 330.

The first roof sealing portion 410 may be adhered to one inner surface of the roof panel 310 in the width direction. The first roof sealing portion 410 may be pressed by the outer surface of the side panel 320 when the roof panel 310 is coupled to the outer frame 100.

The second roof sealing portion 420 may be adhered to the other inner surface of the roof panel 310 in the width direction. The second roof sealing portion 420 may be pressed by the outer surface of the side cover 330 when the roof panel 310 is coupled to the outer frame 100. The second roof sealing portion 420 may be provided in plural to correspond to an upper shape of the side cover 330 in the thickness direction. For example, when the side cover 330 is provided in a U shape, the second roof sealing portion 420 may be provided at each end portion of the side cover 330 in the thickness direction. FIG. 2 illustrates a configuration in which two second roof sealing portions 420 are provided.

The filler member sealing portion 700 may be provided on outer surfaces of the filler members 110 and 120. The filler member sealing portion 700 may be provided on each of outer surfaces of the first filler member 110 and the second filler member 120. The filler member sealing portion 700 may be provided in a strip shape arranged in the filler members 110 and 120 in the width direction. The filler member sealing portion 700 may include, for example, an inner filler member sealing portion 500 and an outer filler member sealing portion 600. To improve watertightness, both end portions of the filler member sealing portion 700 in the thickness direction may be bent in the length direction.

The filler member sealing portion 700 may be manufactured from at least one of a polymer material, an elastomer, or a thermosetting resin. For example, the filler member sealing portion 700 may include at least one of silicone, urethane, acrylic, and butyl rubber.

The assembled frame 200 may be coupled to the outer frame 100. The assembled frame 200 may be coupled to the outer frame 100 at both end portions in the length direction. For example, the assembled frame 200 may be coupled to the first filler member 110 at one end portion and coupled to the second filler member 120 at the other end portion.

The assembled frame 200 may form the skeleton of the clamshell door assembly 1 together with the outer frame 100. The assembled frame 200 may be arranged in the length direction. The assembled frame 200 is provided in a rod shape so that both end portions may be connected to the outer frame 100.

A plurality of assembled frames 200 may be provided. For example, the assembled frame 200 may include a roof panel support assembled frame 200a provided above the outer frame 100 in the thickness direction to support a roof panel 310 and a side panel support assembled frame 200b provided on one side in the width direction to support a side panel 320. Among the assembled frames 200, the roof panel support assembled frame 200a or the side panel support assembled frame 200b disposed in an overlapping portion of the roof panel 310 and the side panel 320 may support the roof panel 310 and the side panel 320 at the same time.

At least one roof panel support assembled frame 200a and at least one side panel support assembled frame 200b may be provided. The roof panel support assembled frame 200a and the side panel support assembled frame 200b may be different only in positions thereof coupled to the outer frame 100 but may have the same configuration. Herein, the roof panel support assembled frame 200a and the side panel support assembled frame 200b are collectively referred to as the ‘assembled frame 200’.

The assembled frame 200 may include an insert frame 210 and a center frame 220. The insert frame 210 may be fixed to the first filler member 110. For example, the insert frame 210 may be fixed to the inside of the first filler member 110. The insert frame 210 may include an insert frame body portion 211 having one end portion fixed to the first filler member 110 and an insert frame bolt portion 212 provided on the other side of the insert frame body portion 211. A screw hole 211a may be provided on one side of the insert frame body portion 211. An insert frame fixing panel 213 may be provided on the first filler member 110. The insert frame body portion 211 may be coupled to the insert frame fixing panel 213 on the inside of the first filler member 110 through a fastening member 214, such as a screw. The insert frame 210 may be connected with the center frame 220 through an insert frame connection hole 110a provided in the first filler member 110.

The insert frame bolt portion 212 may be coupled to the center frame 220. For example, the insert frame bolt portion 212 may be coupled to the center frame part 220a constituting the center frame 220 by penetrating through the insert frame connection hole 110a. A nut portion 222 that may be screw-coupled with the insert frame bolt portion 212 may be provided at an end portion of the center frame part 220a. The insert frame bolt portion 212 may be screw-coupled to the nut portion 222 of the center frame part 220a. The insert frame bolt portion 212 and the bolt portion 221 provided in the center frame part 220a may be provided with the same screw specifications. In other words, both the insert frame bolt portion 212 and the bolt portion 221 may be screw-coupled to the nut portion 222 of the center frame part 220a.

One side of the center frame 220 may be coupled to the second filler member 120. The other side of the center frame 220 may be coupled to the insert frame 210. A pipe nut 230 for coupling with the center frame 220 may be provided inside the second filler member 120. The center frame 220 may be provided by coupling a plurality of center frame parts 220a in one direction. For example, the center frame 220 may be provided by coupling a plurality of center frame parts 220a in the length direction. The bolt portion 221 may be provided at one end portion of the center frame part 220a. The nut portion 222 may be provided at the other end portion of the center frame part 220a. The bolt portion 221 may be screw-coupled to the nut portion 222 of the adjacently disposed center frame 220a.

The bolt portion 221 of any one center frame part 220a disposed adjacent to the second filler member 120 among the center frame parts 220a may be coupled to the second filler member 120. For example, the bolt portion 221 of any one center frame part 220a disposed adjacent to the second filler member 120 may pass through a fastening hole 120a provided in the second filler member 120 and be coupled to the pipe nut 230 provided inside the second filler member 120.

The insert frame bolt portion 212 of the insert frame 210 may be screw-coupled to the nut portion 222 of one of the center frame parts 220a disposed adjacent to the insert frame 210.

The pipe nut 230 and a pipe nut support 231 may be provided to secure the center frame 220 to the outer frame 100 and distribute a load transmitted to the outer frame 100 by the center frame 220. The center frame part 220a of the center frame 220 may be screw-coupled to the pipe nut 230 by penetrating through the fastening hole 120a formed in the outer frame 100.

An upper door mounting bracket 240 may be coupled to the outer frame 100. For example, the upper door mounting bracket 240 may be coupled to upper portions of the first filler member 110 and the second filler member 120. The upper door mounting bracket 240 may be provided to connect a door (not shown) coupled to the clamshell door assembly 1. To this end, a separate upper door hinge (not shown) may be coupled to the upper door mounting bracket 240. At least a portion of the upper door mounting bracket 240 may be welded to the outer frame 100 or may be coupled using a separate fastening device, such as a screw. The upper door mounting bracket 240 may be coupled to the inner side parts of the first filler member 110 and the second filler member 120 provided on both sides in the length direction, respectively. A lower portion 240a of one surface of the upper door mounting bracket 240 facing the outer frame 100 may protrude and be bent toward the outer frame 100. Accordingly, a space may be provided between the upper door mounting bracket 240 and the outer frame 100. A roof panel rib 311 may be inserted into the space and may be seated on the assembled frame 200. At least a portion of the protruded and bent lower portion 240a of the upper door mounting bracket 240 may be welded to the inner side of the outer frame 100. The upper door mounting bracket 240 may be provided with a through-hole 240b through which the assembled frame 200 passes in the length direction. The assembled frame 200 may be coupled to an inner side part of the outer frame 100 by penetrating through the through-hole 240b.

A support flange 241 may be provided to support the upper door mounting bracket 240 and distribute the load transmitted to the upper door mounting bracket 240 to the outer frame 100. The support flange 241 may be provided on one surface of the outer frame 100 facing the upper door mounting bracket 240. The support flange 241 may be coupled to the outer frame 100 by welding or screwing. The support flange 241 may be in contact with both outer surfaces of the upper door mounting bracket 240 in the width direction to support the upper door mounting bracket 240. A portion of the support flange 241 not in contact with the upper door mounting bracket 240 may be bent and coupled to the outer frame 100. For example, the support flange 241 may be provided with a thickness-direction cross-section in an ‘L’ shape. The support flange 241 may be provided in pairs. In other words, the support flange 241 may be provided as a pair spaced apart from an inner surface of the outer frame 100 by a set, selected, or predetermined distance. The inner surfaces of the pair of support flanges 241 may support one outer surface and the other outer surface of the upper door mounting bracket 240 in the width direction, respectively. The load transmitted to the upper door mounting bracket 240 may be distributed through the lower portion 240a of the upper door mounting bracket 240 and the support flange 241 and transmitted to the outer frame 100. Due to this load distribution, the structural stability of the clamshell door assembly 1 may be improved.

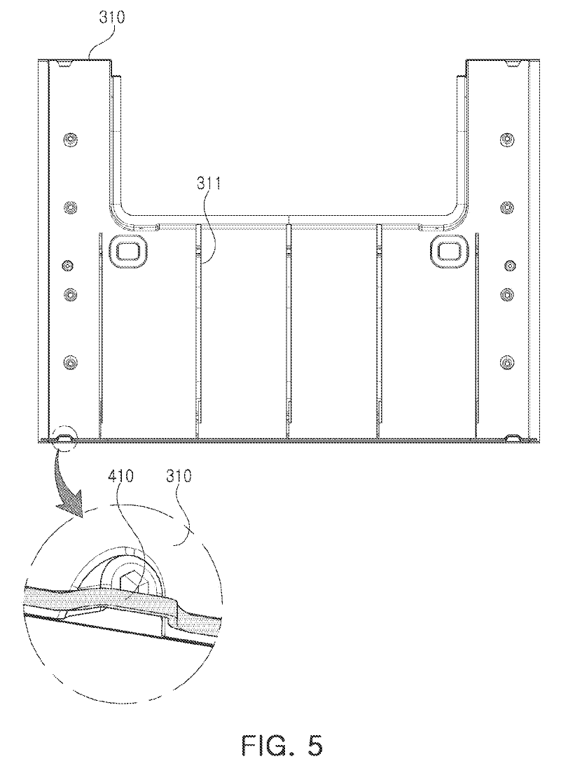

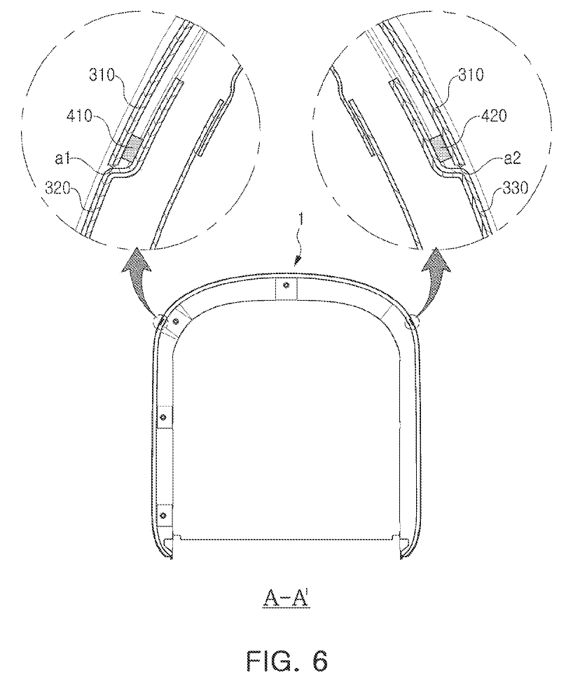

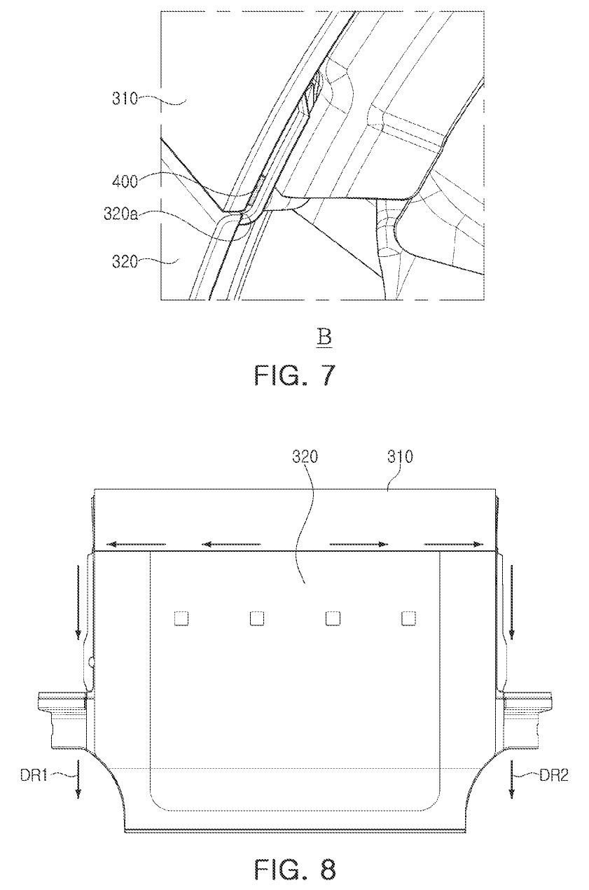

FIG. 5 is a bottom view of the roof panel according to an embodiment of the present disclosure. FIG. 6 is a cross-sectional view taken along line A-A’ of FIG. 1. FIG. 7 is an enlarged view of portion B of FIG. 1. FIG. 8 is a diagram illustrating a path for draining water that has flowed in between the roof panel and the side panel according to an embodiment of the present disclosure.

Referring to FIGS. 5 to 8, the first roof sealing portion 410 may be provided on one end portion of the roof panel 310 in the width direction. The first roof sealing portion 410 may be provided as a strip extending in the length direction. One side of the roof panel 310 in the width direction may be arranged to partially overlap the upper side of the side panel 320 in the thickness direction. The first roof sealing portion 410 may be provided on the inner surface of the roof panel 310 facing the outer surface of the side panel 320. A first gap a1 may be provided between one end portion of the roof panel 310 in the width direction and the side panel 320. The first gap a1 may be connected to a bottom surface of the first roof sealing portion 410. The first gap a1 may be provided in the shape of a passage extending in the length direction. When water is sprayed from the outside onto the roof panel 310 or the side panel 320, such as in a rainy environment, the water may flow into the first gap a1. The water flowing into the first gap a1 may be discharged in at least one direction among both sides in the length direction. The discharge path of the water flowing into the first gap a1 may be determined by the shape of the side panel 320 forming the bottom surface of the first gap a1. For example, if a portion of the side panel 320 constituting the bottom surface of the first gap a1 is provided to slope downward from the longitudinal center to both sides in the length direction, the first gap a1 may also be provided to slope downward from the longitudinal center to both sides in the length direction to correspond thereto. Accordingly, water flowing into the first gap a1 may flow to both sides in the length direction and be discharged. In FIG. 8, paths DR1 and DR2 along which water can flow into the first gap a1 that slopes downward to both sides in the length direction and can be discharged are indicated by the arrows. A drainage recess 320a can open downward in the thickness direction and may be provided on both sides of the first gap a1 in the length direction. The drainage recess 320a may be provided by cutting a portion of the longitudinal end portions of the side panel 320. Water flowing to both sides in the length direction along the first gap a1 may be discharged through the drainage recess 320a.

The second roof sealing portion 420 may be provided on the other end portion of the roof panel 310 in the width direction. The second roof sealing portion 420 may be provided as a strip extending in the length direction. The other side of the roof panel 310 in the width direction may be disposed to partially overlap the upper side of the side cover 330 in the thickness direction. The second roof sealing portion 420 may be provided on the inner surface of the roof panel 310 facing the outer surface of the side cover 330. A second gap a2 may be provided between the other end portion of the roof panel 310 in the width direction and the side cover 330. The second gap a2 may be connected to the bottom surface of the second roof sealing portion 420. The second gap a2 may be provided in the shape of a passage extending in the length direction. When water is sprayed from the outside onto the roof panel 310 or the side cover 330, the water may flow into the second gap a2. The water flowing into the second gap a2 may be discharged in at least one direction among both sides in the length direction. The discharge path of the water flowing into the second gap a2 may be determined by the shape of the side cover 330 forming the bottom surface of the second gap a2. For example, when a portion of the side cover 330 forming the bottom surface of the second gap a2 is provided to slope downward from the longitudinal center to both sides in the length direction, the second gap a2 may also be provided to slope downward from the longitudinal center to both sides in the length direction to correspond thereto. Accordingly, the water flowing into the second gap a2 may flow to both sides in the length direction and be discharged. The drainage recess 320a can open downward in the thickness direction and may be provided on both sides of the second gap a2 in the length direction. The configuration of the drainage recess 320a can be the same as the drainage recess 320a provided on both sides of the first gap a1 in the length direction.

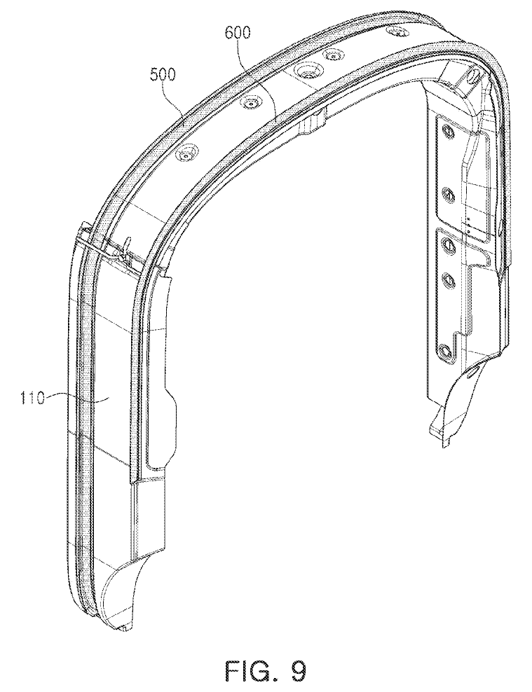

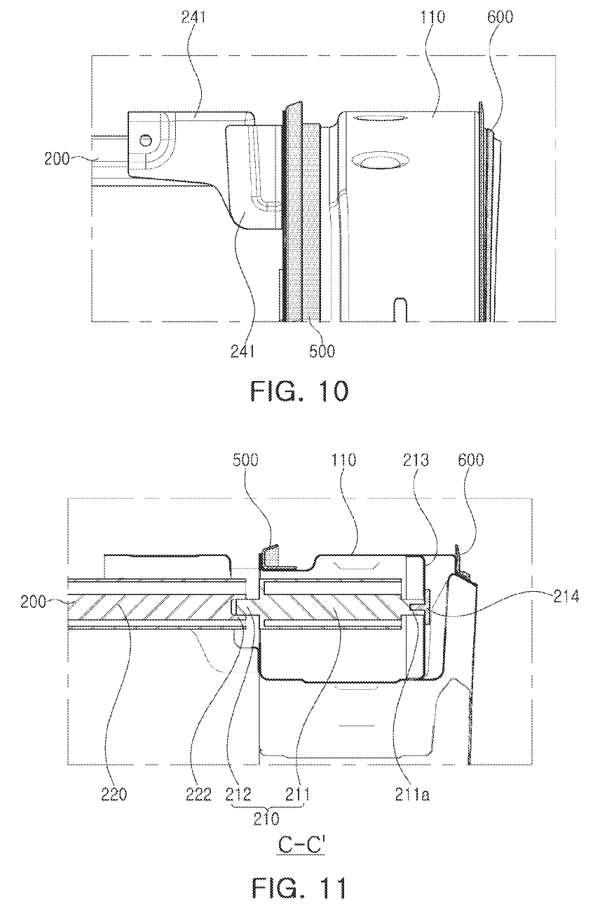

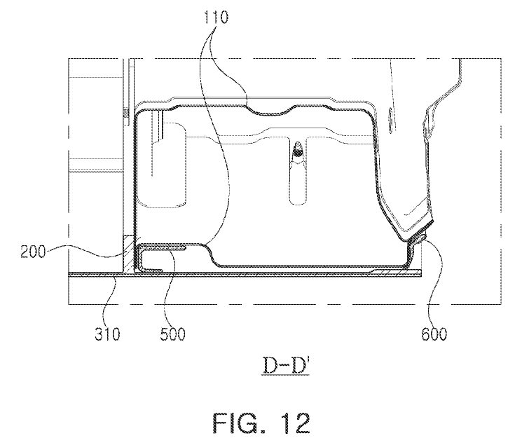

FIG. 9 is a perspective view illustrating a filler member according to an embodiment of the present disclosure, FIG. 10 is a top side view of the filler member according to an embodiment of the present disclosure, FIG. 11 is a cross-sectional view taken along line C-C’ of FIGS. 1, and FIG. 12 is a cross-sectional view taken along line D-D’ of FIG. 1.

Referring to FIGS. 9 to 12, the filler member sealing portion 700 may include, for example, an inner filler member sealing portion 500 and an outer filler member sealing portion 600.

The inner filler member sealing portion 500 may be provided on the longitudinal inner side of the first filler member 110 and the second filler member 120. The outer filler member sealing portion 600 may be provided in the first filler member 110 and the second filler member 120 at a set, selected, or predetermined distance in the longitudinal outer side from the inner filler member sealing portion 500.

A widthwise inner upper portion of the filler member sealing portion 700 may be in close contact with the inner surface of the roof panel 310. In other words, the widthwise inner upper portions of the inner filler member sealing portion 500 and the outer filler member sealing portion 600 may be in close contact with the inner surface of the roof panel 310. Both widthwise side portions of the filler member sealing portion 700 may be in close contact with the inner surfaces of the side panel 320 and the side cover 330. One widthwise side portion of the filler member sealing portion 700 may be in close contact with the inner surface of the side panel 320. The other widthwise side portion of the filler member sealing portion 700 may be in close contact with the inner surface of the side cover 330. For example, one widthwise side portions of the inner filler member sealing portion 500 and the outer filler member sealing portion 600 may be in close contact with the inner surface of the side panel 320. The other widthwise side portions of the inner filler member sealing portion 500 and the outer filler member sealing portion 600 may be in close contact with the inner surface of the side cover 330.

The filler member sealing portion 700 may prevent water from flowing in in the length direction of the clamshell door assembly 1. To improve the watertightness, the end portions of the filler member sealing portion 700 in the thickness direction may be bent in the length direction. By bending the filler member sealing portion 700 at least once, the area in which the filler member sealing portion 700 is in close contact with the filler members 110 and 120, the roof panel 310, and the side panel 320 may increase, and accordingly, the watertightness of the filler member sealing portion 700 may be improved. For example, both end portions of the inner filler member sealing portion 500 in the thickness direction may be bent outward in the length direction. Accordingly, the widthwise cross-section of the inner filler member sealing portion 500 may be provided in an overall ‘C’ shape. The outer filler member sealing portion 600 may be provided so that the bent length of the thicknesswise upper end portion is greater than that of the thicknesswise upper end portion. Accordingly, the widthwise cross-section of the outer filler member sealing portion 600 may be provided in an overall ‘L’ shape. The inner filler member sealing portion 500 and the outer filler member sealing portion 600 may be formed of an elastic soft material, for example, the final combined shape of the inner filler member sealing portion 500 and the outer filler member sealing portion 600 may be deformed to correspond to the inner surface shape of the structure with which the inner filler member sealing portion 500 and the outer filler member sealing portion 600 are in contact. The inner filler member sealing portion 500 and the outer filler member sealing portion 600 may be deformed to correspond to the inner surface shape of the structure in contact therewith and may be in close contact with the inner surface of the structure in contact therewith. The structure with which the inner filler member sealing portion 500 and the outer filler member sealing portion 600 are in contact may be, for example, at least one of the roof panel 310, the side panel 320, or the side cover 330.

A clamshell door assembly according to an embodiment of the present disclosure may improve watertightness performance.

A clamshell door assembly according to an embodiment of the present disclosure may reduce the manufacturing cost, improve the bonding rigidity, and be advantageous in weight reduction.

While example embodiments have been shown and described above, it can be apparent to those skilled in the art that modifications and variations can be made without departing from the scopes of the present disclosure as defined by the appended claims and equivalents thereof.

What is claimed is:

1. A door assembly comprising:
an outer frame including a filler member;
a roof panel connected to an upper portion of the outer frame;
a side panel connected to a first outer-frame side of the outer frame to cover a first filler-member side of the filler member and at least partially underlapping the roof panel;
a side cover connected to a second outer-frame side of the outer frame to cover a second filler-member side of the filler member and at least partially underlapping the roof panel;
a roof sealing portion disposed on a roof-panel inner surface of the roof panel; and
a filler-member sealing portion disposed on a filler-member outer surface of the filler member.

2. The assembly of claim 1, wherein the roof sealing portion includes:
a first roof sealing portion disposed between the roof panel and the side panel; and
a second roof sealing portion disposed between the roof panel and the side cover.

3. The assembly of claim 2, wherein the first roof sealing portion is bonded to the roof-panel inner surface of the roof panel and pressed by a side-panel outer surface of the side panel, and the second roof sealing portion is bonded to the roof-panel inner surface of the roof panel and pressed by a side-cover outer surface of the side cover.

4. The assembly of claim 2, wherein a first roof-panel side of the roof panel in a width direction is disposed to overlap a side-panel underlap portion of an upper side-panel side of the side panel in a thickness direction,
wherein a first gap adjacent a first-roof-sealing-portion bottom surface of the first roof sealing portion is disposed between a first end portion of the roof panel in the width direction and the side panel,
wherein a second roof-panel side of the roof panel in the width direction is disposed to overlap a side-cover underlap portion of an upper side-cover side of the side cover in the thickness direction, and
wherein a second gap adjacent a second-roof-sealing-portion bottom surface of the second roof sealing portion is disposed between a second end portion of the roof panel in the width direction and the side cover.

5. The assembly of claim 4, wherein the first gap and the second gap are disposed in a shape of a passage extending in a length direction of the outer frame.

6. The assembly of claim 5, wherein a drainage recess opens downward and is disposed on both lengthwise sides of each of the first gap and the second gap.

7. The assembly of claim 5, wherein the first gap and the second gap are disposed to slope downward from a center region in the length direction to both lengthwise sides of each of the first gap and the second gap.

8. The assembly of claim 1, wherein a widthwise inner upper portion of the filler-member sealing portion is in contact with the roof-panel inner surface of the roof panel,
wherein a first widthwise side portion of the filler-member sealing portion is in contact with a side-panel inner surface of the side panel, and
wherein a second widthwise side portion of the filler-member sealing portion is in contact with a side-cover inner surface of the side cover.

9. The assembly of claim 1, wherein the filler-member sealing portion includes:
an inner filler-member sealing portion disposed on an inner filler-member side of the filler member in a length direction; and
an outer filler-member sealing portion disposed on an outer filler-member side of the filler member in the length direction and spaced apart from the inner filler-member sealing portion by a first distance in the length direction.

10. The assembly of claim 1, wherein the filler member includes:
a first filler member disposed on a first lengthwise side of the outer frame; and
a second filler member spaced apart from the first filler member by a first distance in a length direction, wherein the filler-member sealing portion is disposed at each of the first filler member and the second filler member.

11. A clamshell door assembly comprising:
an outer frame including a first filler member and a second filler member;
an assembled frame fixed to the outer frame;
a roof panel connected to an upper portion of the outer frame and seated on the assembled frame;
a side panel connected to a first outer-frame side of the outer frame and seated on the assembled frame;
a side cover connected to a second outer-frame side of the outer frame and covering a first-filler-member side part of the first filler member and a second-filler-member side part of the second filler member;
a roof sealing portion disposed on an inner surface of the roof panel; and
a filler member sealing portion disposed on an outer surface of each of the first filler member and the second filler member.

12. The assembly of claim 11, wherein the roof panel includes a roof panel rib protruding toward the assembled frame on a roof-panel inner surface, and wherein the roof panel rib includes a roof panel rib recess into which the assembled frame is inserted.

13. The assembly of claim 11, wherein the side panel includes a side panel rib protruding toward the assembled frame on a side-panel inner surface, and wherein the side panel rib includes a side panel rib recess into which the assembled frame is inserted.

14. The assembly of claim 11, wherein the assembled frame includes:
an insert frame fixed to the first filler member; and
a center frame having a first center-frame side connected to the insert frame and a second center-frame side fixed to the second filler member.

15. The assembly of claim 14, wherein the center frame includes a plurality of center frame parts coupled together.

16. A vehicle body comprising:
an outer frame comprising a first filler member and a second filler member, wherein the second filler member is spaced apart from the first filler member in a lengthwise direction of the vehicle body;
structure frame members extending in the lengthwise direction between the first filler member and the second filler member with a first group of the structure frame members on a first widthwise side of the vehicle body and with a second group of the structure frame members on an upper roof side of the vehicle body, wherein the structure frame members are spaced apart from each other, wherein a first-structure-frame-member end of each of the structure frame members is fixed to the first filler member, and wherein a second-structure-frame-member end of each of the structure frame members is fixed to the second filler member;
a side panel;
side panel ribs protruding from an inner side-panel surface of the side panel, wherein the side panel is connected to the first filler member to cover a first-filler-member first-widthwise-side portion of the first filler member, wherein the side panel is connected to the second filler member to cover a second-filler-member first-widthwise-side portion of the second filler member, and wherein the side panel ribs are coupled to the first group of the structure frame members;
a roof panel;
roof panel ribs protruding from an inner roof-panel surface of the roof panel, wherein the roof panel is connected to the first filler member to cover a first-filler-member upper-roof-side portion of the first filler member, wherein the roof panel is connected to the second filler member to cover a second-filler-member upper-roof-side portion of the second filler member, wherein the roof panel ribs are coupled to the second group of the structure frame members, wherein the roof panel overlaps with an upper-side-panel end of the side panel at the first widthwise side of the vehicle body;
a side cover on a second widthwise side of the vehicle body, wherein the side cover is connected to at least one of the first filler member to cover a first-filler-member second-widthwise-side portion of the first filler member or the second filler member to cover a second-filler-member second-widthwise-side portion of the second filler member, wherein the roof panel overlaps with an upper-side-cover end of the side cover at the second widthwise side of the vehicle body; and
sealing members between the roof panel and at least one of the outer frame, the side panel, or the side cover.

17. The vehicle body of claim 16, wherein each of the side panel ribs has side-panel-rib recess openings that receive therein the first group of the structure frame members, and
wherein each of the roof panel ribs has roof-panel-rib recess openings that receive therein the second group of the structure frame members.

18. The vehicle body of claim 16, wherein the sealing members comprise:
a first roof sealing portion disposed between and in contact with the roof panel and the side panel where the roof panel overlaps with the upper-side-panel end of the side panel; and
a second roof sealing portion disposed between and in contact with the roof panel and the side cover where the roof panel overlaps with the upper-side-cover end of the side cover.

19. The vehicle body of claim 16, wherein the sealing members comprise:
a first filler-member sealing portion disposed between and in contact with the roof panel, the side panel, the side cover, and the first filler member; and
a second filler-member sealing portion disposed between and in contact with the roof panel, the side panel, the side cover, and the second filler member.

20. The vehicle body of claim 16, further comprising:
a first-widthwise-side edge of the roof panel;
a first gap on the first widthwise side between the first-widthwise-side edge of the roof panel and the side panel where the roof panel overlaps with the upper-side-panel end of the side panel, wherein the first-widthwise-side edge of the roof panel is sloped downward such that the first gap slopes downward;
a second-widthwise-side edge of the roof panel; and
a second gap on the second widthwise side between the second-widthwise-side edge of the roof panel and the side cover where the roof panel overlaps with the upper-side-cover end of the side cover, wherein the second-widthwise-side edge of the roof panel is sloped downward such that the second gap slopes downward.
